(19) United States
(12) Patent Application Publication
(10) Pub. No.: US 2026/0241393 A1
(43) Pub. Date: Aug. 20, 2026

(54) CENTRIFUGAL SEPARATOR

(71) Applicant: Alfa Laval Corporate AB, LUND (SE)

(72) Inventor: Kasper HÖGLUND, Rönninge (SE)

(73) Assignee: Alfa Laval Corporate AB, LUND (SE)

(21) Appl. No.: 19/494,687

(22) PCT Filed: Mar. 25, 2024
(86) PCT No.: PCT/EP2024/057991

§ 371 Date: Dec. 18, 2025

(30) Foreign Application Priority Data
Apr. 18, 2023 (EP) 23168459.8

(51) Int. Cl. B04B 7/08; B04B 7/00; B04B 9/02; B04B 9/12; B04B 11/02; B04B 15/00

(52) U.S. Cl. CPC B04B 7/08; B04B 9/02; B04B 9/12; B04B 11/02; B04B 15/00; B04B 2007/005

(57) ABSTRACT

The disclosure concerns a centrifugal separator comprising a rotatable assembly configured to rotate about a rotational axis, a casing which delimits at least part of a space, and a pump arrangement connected to the space. The space is sealed, and the pump arrangement is configured to remove gas from the space to provide a negative pressure within the space. The rotatable assembly comprises a centrifuge bowl arranged within the space. The rotatable assembly is connected to a fixed structure via a securing structure that is rigid in at least one direction along the rotational axis such that the centrifuge bowl is maintainable in an axial position along the rotational axis when the space is subjected to the negative pressure. The securing structure comprises an elongated element.

### TECHNICAL FIELD

The invention relates to a centrifugal separator.

### BACKGROUND

EP 2403650 discloses a centrifugal separator comprising a casing which delimits and seals off a space in which a centrifuge bowl is arranged. The centrifuge bowl forms a separation space which is sealed or isolated from the space, and in which separation space centrifugal separation of a higher density and a lower density component from a fluid takes place. An inlet extends into the centrifuge bowl for introducing fluid to the separation space, and a first outlet extends from the centrifuge bowl for discharge of a component separated from the fluid. The space is connected to a pump device which is arranged to remove gas, thereby maintaining negative pressure in said space. The centrifuge bowl comprises at least one second outlet extending from the separation space to the space for discharge of at least one higher density component separated from the fluid.

During operation of a centrifugal separator of the above discussed kind, the negative pressure i.e., a sub-atmospheric pressure, in the space surrounding the centrifuge bowl reduces heat generated by friction between the rotating centrifuge bowl and the gas within the space. This is advantageous e.g., when the fluid being separated and/or one or both separated components are negatively affected by heat. Cooling of the centrifugal separator thus, may be avoided or at least the need for cooling of the centrifugal separator is reduced. Other advantages of operating the centrifuge bowl with negative pressure prevailing in the space may be one or more of reduced noise and reduced energy consumption.

### SUMMARY

A fluid mixture to be separated is led into a centrifuge bowl of a centrifugal separator and one or more separated phases are led from the centrifuge bowl. Since the centrifuge bowl is arranged to be rotated within a space of the centrifugal separator, a spindle and at least one conduit for the fluid mixture and one conduit for a separated phase have to lead through the space in order to connect with the centrifuge bowl. Accordingly, one or more seals have to be provided between stationary parts of the centrifugal separator and rotating parts of the centrifugal separator. Moreover, rotor dynamics e.g., imbalances and passing of critical speeds, affect the rotating parts of the centrifugal separator, including inter alia the centrifuge bowl. Portions of the centrifugal separator supporting the rotating parts, are therefore arranged to permit limited radial relative movement between rotating parts and stationary parts of the centrifugal separator.

When a centrifugal separator is operated with a pressure difference between the space in which the centrifuge bowl is arranged and an ambient pressure, the pressure difference affects elements that delimit the space from its ambient environment. Such elements may include inter alia one or more of casing portions, elements forming part of sealing arrangements between stationary and rotating parts, and elements providing for radial movement between stationary and rotating parts.

The pressure difference produces a resulting force on each separate element delimiting the space from its ambient environment. The resulting force is proportional to the area of the respective separate element facing the space. An element that is stationary during operation of the centrifugal separator and directly attached to a fixed structure is prevented from being displaced by the resulting force. However, elements that are movable relative to such stationary elements are affected by the respective resulting force.

It would be advantageous to achieve a centrifugal separator overcoming, or at least alleviating, effects of the above discussed pressure difference between the space in which the centrifuge bowl is arranged and an ambient pressure. In particular, it would be desirable to enable a centrifuge bowl of a centrifugal separator to maintain an axial position within a space that is subjected to a pressure difference in relation to an ambient environment. To better address one or more of these concerns, a centrifugal separator having the features defined in the independent claim is provided.

According to an aspect of the invention, there is provided a centrifugal separator comprising a rotatable assembly configured to rotate about a rotational axis, a casing which delimits at least part of a space, a pump arrangement connected to the space, an inlet conduit, and at least one outlet conduit. The space is sealed, and the pump arrangement is configured to remove gas from the space to provide a negative pressure within the space during operation of the centrifugal separator. The rotatable assembly comprises a centrifuge bowl and a spindle, the centrifuge bowl being arranged within the space and within the casing and the spindle being connected to the centrifuge bowl and extending between the centrifuge bowl and a drive arrangement outside the casing. The centrifuge bowl delimits a separation chamber and the inlet conduit and the at least one outlet conduit are arranged in fluid communication with the separation chamber from outside the casing. The rotatable assembly is suspended to permit movement thereof relative to at least a portion of the casing in a radial direction with respect to the rotational axis. The rotatable assembly is connected to a fixed structure via a securing structure that is rigid in at least one direction along the rotational axis such that the centrifuge bowl is maintainable in an axial position along the rotational axis when the space is subjected to the negative pressure. The securing structure comprises an elongated element aligned with the rotational axis when the rotatable assembly is standing still. The securing structure is connected to the fixed structure at a first end portion of the elongated element and an opposite second end portion of the elongated element is movable in the radial direction. The elongated element is nonelastic under tensile load.

Since the rotatable assembly is suspended to permit movement thereof relative to at least a portion of the casing in the radial direction—the rotatable assembly is suspended to manage rotor dynamics affecting the rotatable assembly. Moreover, since the rotatable assembly is connected to the fixed structure via the securing structure that is rigid in at least one direction along the rotational axis, since the securing structure comprises the elongated element aligned with the rotational axis, since the securing structure is connected to the fixed structure at the first end portion of the elongated element and the second end portion is movable in the radial direction, and since, the elongated element is nonelastic under tensile load—the centrifuge bowl is maintained in an axial position along the rotational axis when the space is subjected to the negative pressure during use of the centrifugal separator in a manner that allows for rotor dynamics to affect the rotatable assembly without harming the centrifugal separator.

More specifically, since rotor dynamics affect the rotatable assembly, the rotatable assembly is suspended in a manner that handles rotor dynamic effects while ensuring that the centrifugal separator operates reliably. For instance, fluids must be able to flow into and out from the separation chamber, sealing arrangements must maintain their sealing function, and the rotatable assembly has to be rotatable. The suspension of the rotatable assembly permitting the movement in the radial direction typically ensures that rotor dynamics affecting the rotatable assembly can do so to a limited degree. Thus, neither the operation of the centrifugal separator nor the rotatable assembly is negatively affected by rotor dynamic effects. As discussed above, connections to the centrifuge bowl within the space subjected to negative pressure, lead to different portions of the casing, within which the centrifuge bowl is arranged, to be subjected to forces caused by the pressure difference between the negative pressure and ambient pressure. Parts affected by such forces may be related to the radial movability of the rotatable assembly and/or fluids flowing to and from the separation chamber in the centrifuge bowl. The securing structure that is connected to the fixed structure ensures that the forces caused by the pressure difference do not displace the centrifuge bowl in an axial direction along the rotational axis. Since the securing structure is rigid in at least one direction along the rotational axis and the elongated element is nonelastic under tensile load, the axial position of the centrifuge bowl is maintained during use of the centrifugal separator. Moreover, since the elongated element is aligned with the rotational axis and the second end portion of the elongated element is movable in the radial direction, the securing structure provides for rotor dynamics affecting the rotatable assembly to do so to a limited degree in order to ensure proper operation of the centrifugal separator and the rotatable assembly.

An alternative to the securing structure would be to provide substantially equally sized parts which are affected by the pressure difference i.e., parts having substantially equal areas, on opposite sides of the casing. Thus, the forces affecting the axial position of the centrifuge bowl would balance each other. However, such particular approach would require structure construction of the parts affected by the pressure difference.

The centrifugal separator is a high-speed centrifugal separator i.e., the rotatable assembly and the centrifuge bowl is rotatable at several thousand rotations per minute, such as at 3000-12000 rpm or higher, during use of the centrifugal separator.

The casing is stationary with respect to the rotatable assembly during use of the centrifugal separator.

The fixed structure is a solid foundation that serves to securely support parts of the centrifugal separator. The fixed structure may comprise a stand of the centrifugal separator. The fixed structure may form part of the centrifugal separator or may be separate from the centrifugal separator.

The drive arrangement may comprise an electric motor connected via a transmission to the spindle. Alternatively, a rotor of the electric motor may be directly connected to the spindle or a rotor shaft of the electric motor may form part of the spindle.

When the centrifugal separator is positioned for use thereof, the axial extension of the rotational axis may extend in a vertical direction.

Herein, the terms axial and radial relate to the rotational axis. An axial direction extends in parallel with the rotational axis of the centrifuge bowl and a radial direction extends perpendicularly to the rotational axis.

During use of the centrifugal separator, separation of a liquid feed mixture is performed in the separation chamber of the centrifugal separator. A separation aid e.g., comprising a stack of frustoconical separation discs, may be arranged in the separation chamber. In the field, sometimes, the separation chamber is referred to as a separation space.

During use of the centrifugal separator, a liquid feed mixture is led into the separation chamber along the rotational axis. A separated light phase is led out of the separation space along the rotational axis or radially close to the rotational axis. A separated heavy phase may be led out of the separation space along the rotational axis or radially close to the rotational axis. A sludge phase may be separated from the liquid mixture and may be discharged through outlet openings arranged at a periphery of the centrifuge bowl.

As mentioned above, the casing delimits at least part of the space that is set under negative pressure during use of the centrifugal separator. Thus, the negative pressure prevails in between the centrifuge bowl and the casing. Accordingly, the above discussed advantages of operating the centrifuge bowl in negative pressure i.e., sub-atmospheric pressure, are provided.

According to some embodiments, a further portion of the space may be delimited by a housing connected to the casing. The housing may be a housing of an electric motor and/or of a transmission.

The space is sealed relative to surroundings of the casing and according to some embodiments, relative surroundings of other components, such as a housing, that together define the space.

The pump arrangement is arranged to remove gas, such as air, from the space, thereby maintaining in the space a negative pressure, i.e. a pressure lower than atmospheric pressure such as an absolute pressure of 1-80 kPa.

A suspension of the rotatable assembly may be arranged in any manner that permits the radial direction movement of the rotatable assembly relative to at least a portion of the casing. The suspension as such and/or other elements may limit the extent, to which the rotatable assembly is movable in the radial direction. Such radial movement limitation may depend on e.g., the size and type of centrifugal separator the type and number of fluid connections to and from the separation chamber in the centrifuge bowl, etc. Moreover, at different axial portions of the rotatable assembly different extents of radial movement may be permitted. For instance, at sealing arrangements of fluid inlet and/or outlet connections only a small radial movement may be permitted while the farther from such fluid sealing arrangements, the larger a radial movement may be permitted.

Fluid seals may be provided at one or more of the inlet and outlet conduits, depending on whether the one or more of the inlet and outlet conduits form part of interfaces between the rotatable assembly and stationary portions of the centrifugal separator.

The rotatable assembly may be journaled in the securing structure.

In addition to the elongated element, the securing structure may comprise one or more of a housing, a bearing seat, a pipe section, a frame, a latticework, etc.

As such, the securing structure extends between the rotatable assembly and the fixed structure. The elongated element may form part of a final link of the securing structure to the fixed structure.

The securing structure may be directly or indirectly connected to the fixed structure via further connecting elements i.e., other than via the elongated element only.

Since the elongated element is aligned with the rotational axis when the rotatable assembly is standing still, since the first end portion of the elongated element is connected to the fixed structure, and since its second end portion is movable in the radial direction, the elongated element may act as a pivotable element, which can pivot at its first end portion at, or near, the fixed structure. Since the elongated element has an extension along the axial direction, the axial position of the securing structure and thus, of the rotatable assembly, varies only to a minor degree as a consequence of such pivoting of the elongated element.

Also, it may be noted that movement in the radial direction of the rotatable assembly and of the second end portion of the elongated element may occur only occasionally during operation of the centrifugal separator, e.g. due to rotor dynamic effects when a rotational speed of the rotatable assembly passes a critical speed or due to imbalances when a sludge phase is ejected from the centrifuge bowl. During operation of the centrifugal separator, the rigidity of the securing structure, including the nonelastic properties of the elongated element, ensures that the axial position of the centrifuge bowl is maintained within a limited range.

The herein discussed movements in the radial direction of the rotatable assembly and of the second end portion of the elongated element, each is a limited movement provided to handle rotor dynamic effects of the rotatable assembly while ensuring proper operation of the centrifugal separator.

Maintaining the axial position of the centrifuge bowl during use of the centrifugal separator means maintaining the axial position within of the centrifuge bowl within an axial range. The centrifugal separator is devised for the centrifuge bowl to be positioned with an axial range e.g., the axial position of the centrifuge bowl may shift within fractions of a millimetre up to a few millimetres, such as 0.5-3 mm e.g., depending on a size of the centrifugal separator.

The magnitude of the resulting force affecting the axial position of the centrifuge bowl and caused by the pressure difference depends on the area or areas of the parts that are connected to the rotatable assembly and that are affected i.e., displaceable by the pressure difference, on the weight of the centrifuge bowl, and on the magnitude of the pressure difference.

When the resulting force from the pressure difference is directed upwardly, the weight of the rotatable assembly will counter the effect that the resulting force has on the axial position of the centrifuge bowl. In such instances, the heavier the centrifuge bowl, the more the resulting force is countered. Consequently, the lighter the rotatable assembly, the more pronounced is the problem with the axial displacement of the centrifuge bowl. Thus, contrary to an initial inkling, the problem with maintaining an axial position of the centrifuge bowl is bigger in small centrifugal separators than in large centrifugal separators with centrifuge bowls weighing several hundreds of kilograms.

Mentioned purely as an example, in a small centrifugal separator a casing portion below the centrifuge bowl may have a diameter of 275 mm and a sealing arrangement above the centrifuge bowl may have a diameter of 37 mm. When subjected to a pressure difference of 1 bar (100 kPa), the resulting force is 5.8 kN affecting the centrifuge bowl in an upward direction. The herein discussed securing structure ensures that despite being subjected to this resulting force, the centrifuge bowl is maintained at an axial position.

According to embodiments, the securing structure may comprise a housing, and the rotatable assembly may be journalled in the housing. In this manner, the rotatable assembly may be journaled in the securing structure.

According to embodiments, the drive arrangement may comprise an electric motor, wherein the rotatable assembly may comprise a rotor of the electric motor, and wherein the housing may be a housing of the electric motor. In this manner, the housing of the electric motor may form part of the securing structure.

According to embodiments, the elongated element may comprise a tie rod, and/or a wire, and/or a cord. In this manner, an elongated element that is nonelastic may be provided.

For instance, a nonelastic tie rod may be made from a steel material, a nonelastic wire may be a steel wire, and a nonelastic cord may be an aramid cord.

Herein, the elongated element being nonelastic under tensile load means that the elongated element is dimensioned for not being extended by the axial forces that the rotatable assembly is subjected to during use of the centrifugal separator due to the negative pressure in the space. In practice, since no material is totally rigid, the extension of the elongated member may be e.g., ≤1 mm.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIG. 1 schematically illustrates a cross section through a centrifugal separator according to embodiments,

FIG. 2 schematically illustrates a cross section through a centrifugal separator according to embodiments, and

FIGS. 3a and 3b illustrate portions of securing structures according to embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

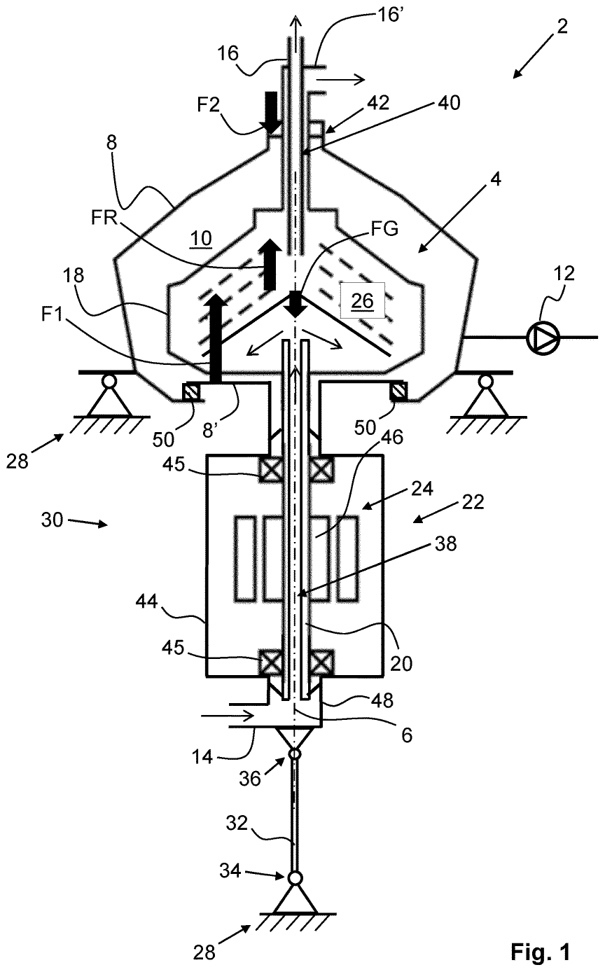

FIG. 1 schematically illustrates a cross section through a centrifugal separator 2 according to embodiments.

Centrifugal separators, their main constructional features, and their operational principles for separating a liquid feed mixture into a light phase as well as into a heavy phase and/or a sludge phase are known. Other than when related to the present aspect of maintaining an axial position of a centrifuge bowl within a centrifugal separator, such features and operational principles of centrifugal separators, therefore, are not discussed herein.

The centrifugal separator 2 comprises a rotatable assembly 4 configured to rotate about a rotational axis 6, a casing 8, 8′ which delimits at least part of a space 10, a pump arrangement 12 connected to the space 10, an inlet conduit 14, and at least one outlet conduit 16, 16′.

The rotatable assembly 4 comprises a centrifuge bowl 18 and a spindle 20. The centrifuge bowl 18 is arranged within the space 10 and within the casing 8, 8′. The spindle 20 is connected to the centrifuge bowl 18 and extends between the centrifuge bowl 18 and a drive arrangement 22 arranged outside the casing 8, 8′.

The centrifuge bowl 18 is supported and driven by the spindle 20. The centrifuge bowl 18 is rotatably arranged inside the casing 8, 8′. The casing 8, 8′ is stationary and the rotatable assembly 4 is rotatable in relation to the casing 8, 8′.

The rotatable assembly 4 is driven to rotate about the rotational axis 6 by the drive arrangement 22. The drive arrangement 22 may comprise an electric motor 24.

In the illustrated embodiments, the spindle 20 is directly driven by the electric motor 24. In alternative embodiments, a transmission may be arranged between the electric motor and the spindle.

The centrifuge bowl 18 delimits a separation chamber 26. The inlet conduit 14 and the at least one outlet conduit 16, 16′ are arranged in fluid communication with the separation chamber 26 from outside the casing 8, 8′.

The space 10 is sealed. Accordingly, the space 10 is sealed at least from an ambient environment of the casing 8, 8′.

The pump arrangement 12 is configured to remove gas from the space 10 to provide a negative pressure within the space 10 during operation of the centrifugal separator 2.

The rotatable assembly 4 is suspended to permit movement thereof relative to at least a portion of the casing 8, 8′ in a radial direction with respect to the rotational axis 6 e.g., cause occasionally by rotor dynamic effects. Such movement in the radial direction is limited.

The rotatable assembly 4 is connected to a fixed structure 28 via a securing structure 30 that is rigid in at least one direction along the rotational axis 6 such that the centrifuge bowl 18 is maintainable in an axial position along the rotational axis 6 when the space 10 is subjected to the negative pressure during use of the centrifugal separator 2.

The securing structure 30 comprises an elongated element 32 aligned with the rotational axis 6 when the rotatable assembly 4 is standing still i.e., when the centrifugal separator 2 is not in use. The securing structure 30 is connected to the fixed structure 28 at a first end portion 34 of the elongated element 32 and an opposite second end portion 36 of the elongated element 32 is movable in the radial direction. Such movement in the radial direction is limited.

Also during use of the centrifugal separator 2, the elongated element 32 may be aligned with the rotational axis 6. However, the movement in the radial direction caused e.g., by rotor dynamic effects, may cause occasional misalignment of the elongated element 32 and the rotational axis 6.

The elongated element 32 is nonelastic under tensile load.

As discussed above, the securing structure 30 including the elongated element 32 being connected to the fixed structure 28 ensures that an axial position of the centrifuge bowl 18 is maintained, at least within a limited axial range.

More specifically, during use of the centrifugal separator 2 when the space 10 is subjected to negative pressure i.e., having a lower pressure than the ambient environment, parts of the centrifugal separator 2 are affected by forces caused by the pressure difference. Due to the rotatable assembly being suspended to handle rotor dynamic effects such forces would affect the axial position of the centrifuge bowl 18 were it not for the securing structure 30.

In the illustrated embodiments, a portion 8′ of the casing 8, 8′ is indirectly connected to the rotatable assembly 4. The portion 8′ provides for the radial movement of the rotatable assembly 4 and accordingly, is moveable in relation to other portions 8 of the casing 8, 8′.

The force F1 affecting the portion 8′ is indicated by a broad arrow. Further, at the outlet conduits 16, 16′ a seal 42 provides an interface between the rotatable assembly 4 and stationary portions of one or more of the outlet conduits 16, 16′ and/or the casing 8. The force F2 affecting the rotatable portion of the seal 42 is indicated with a broad arrow.

Moreover, the rotatable assembly 4 has a weight which results in a gravitational force FG affecting the rotatable assembly 4. The gravitational force FG is indicated with a broad arrow. The resultant force FR affecting the centrifuge bowl 18 is the vector sum of the above-mentioned forces F1, F2, and FG. F1>F2 due to the portion 8′ of the casing 8, 8′ having a larger area than the seal 42. When the gravitational force FG is small in comparison with the force F1, the resultant force FR is directed in an upward direction along the rotational axis 6, as in the illustrated embodiments.

Accordingly, in the illustrated embodiments, the securing structure 30 is rigid at least in the upward direction along the rotational axis 6. Thus, the securing structure 30 ties the rotatable assembly 4 and thus, the centrifuge bowl 18 to the fixed structure 28. An axial displacement of the centrifuge bowl 18 is thus, avoided or a at least limited to a small axial range that is permittable without affecting the centrifugal separator 2 negatively.

According to embodiments, such as the illustrated embodiments, at least one of a first fluid connection 38 between the inlet conduit 14 and the separation chamber 26 and a second fluid connection 40 between the at least one outlet conduit 16, 16′ and the separation chamber 26 extends into the separation chamber 26 at an end of the centrifuge bowl 18 opposite to the spindle 20, wherein there is arranged a seal 42 between the rotatable assembly 4 and conduits 14, 16, 16′ at the end of the centrifuge bowl 18 opposite to the spindle 20.

### For Instance, the Seal 42 May Be a Mechanical Hermetical Seal.

According to embodiments, such as the illustrated embodiments, at least one of the first fluid connection 38 between the inlet conduit 14 and the separation chamber 26 and the second fluid connection 40 between the at least one outlet conduit 16, 16′ and the separation chamber 26 extends through the spindle 20.

More specifically, in the illustrated embodiments, the inlet conduit 14 and the first fluid connection 38 leading into the separation chamber 26 is arranged below a lower end of, the centrifuge bowl 18. The first fluid connection 38 extends through the spindle 20, which is hollow for this purpose.

The outlet conduit 16 for separated light phase is arranged above an upper end of the centrifuge bowl 18.

Optionally, as illustrated in FIG. 1, there may be provided a further outlet conduit 16′ for a separated heavy phase arranged above an upper end of the centrifuge bowl 18.

However, the centrifugal separator 2 is not limited to this arrangement of inlet and outlet conduits. For instance, the liquid feed mixture may be led into the separation chamber via a conduit from above the centrifuge bowl. The light phase and/or a heavy phase may be led from the separation space via a hollow spindle downwardly from the centrifuge bowl.

Furthermore, the centrifuge bowl may be provided with peripheral outlet openings (not shown) for ejecting a sludge phase into the space 10. In such case, the casing 8 suitably, is provided with an outlet for the sludge phase.

According to embodiments, the securing structure 30 may comprise a housing 44, and the rotatable assembly 4 may be journalled in the housing 44.

In this manner, the rotatable assembly 4 may be rotatably supported in the securing structure 30. Moreover, in this manner the rotatable assembly 4 and thus, the centrifuge bowl 18, may be connected to the securing structure 30 for maintaining the axial position of the centrifuge bowl 18 during use of the centrifugal separator 2.

For instance, a set of bearings 45, such as a set of ball bearings, may provide the journaling of the rotatable assembly 4. The set of bearings 45 may be arranged between the housing 44 and the spindle 20.

According to embodiments, such as the illustrated embodiments, the spindle 20 may be journaled in the housing 44. In this manner, the rotatable assembly 4 may be journaled in the housing 44 via the spindle 20.

According to embodiments wherein the drive arrangement comprises an electric motor 24, such as the illustrated embodiments, the rotatable assembly 4 may comprise a rotor 46 of the electric motor 24, and the housing may be a housing 44 of the electric motor 24.

Thus, the housing 44 of the electric motor 24 may form part of the securing structure 30.

For instance, the rotor 46 of the electric motor 24 may be integrated with the spindle 20.

According to alternative embodiments, the housing 44 may form part of a housing of a transmission.

The elongated element 32 is connected at its second end portion 36 to the housing 44. In this manner, the elongated element 32 may be included in the securing structure 30 to form part of the rigid connection provided by the securing structure 30.

The Second End Portion 36 of the Elongated Element 32 May Be Directly or Indirectly connected to the housing 44.

In the illustrated embodiments, the second end portion 36 of the elongated element 32 is indirectly connected to the housing 44 via a connection portion 48 of the inlet conduit 14. For instance, if all inlet and outlet conduits are arranged above the centrifuge bowl 18, the second end portion 36 of the elongated element 32 may connect directly to the housing 44.

As mentioned above, the casing 8, 8′ may comprise more than one portion.

For instance, a first portion 8 of the casing 8, 8′ may be connected to the fixed structure 28, a second portion 8′ of the casing 8, 8′ may be connected to the housing 44, and a seal 50 may be provided between the first and second portions 8, 8′ of the casing 8, 8′. In this manner, the radial movement of the rotatable assembly 4 may be achieve while the casing 8, 8′ may still provide for the space 10 to be sealed for maintenance of the negative pressure therein.

More specifically, the second portion 8′ of the casing 8, 8′ is associated with the rotatable assembly 4 and thus, is arranged to move with at least a portion of the rotatable assembly 4 in the radial direction. The seal 50 between the first and second portions 8, 8′ of the casing ensure that the pump arrangement 12 is able to provide the negative pressure within the space 10.

Accordingly, the spindle 20 may extend through the second portion 8′ of the casing 8, 8′.

The casing may comprise further portions than the first and second portions 8, 8′.

According to embodiments, such as the illustrated embodiments, the rotatable assembly 4 may be suspended at the seal 50 between the first and second portions 8, 8′ of the casing 8, 8′.

In this manner, the rotatable assembly 4 may be conveniently suspended in the centrifugal separator 2 to provide the radial movement of the rotatable assembly 4. The securing structure 30 ensures that the seal 50 does not rupture due to the negative pressure within the space 10 during use of the centrifugal separator 2.

A tensile load is transmittable via the second portion 8′ of the casing, the housing 44, and the elongated element 32 to the fixed structure 28.

Accordingly, the second portion 8′ of the casing is directly or indirectly connected to the housing 44.

The magnitude of the radial movement of the rotatable assembly 4 varies depending inter alia on the size of the rotatable assembly 4, the grade of rotor dynamics affecting the rotatable assembly 4, the amount of imbalances, etc. Moreover, the radial movement of the rotatable assembly 4 varies between different axial positions along the rotatable assembly 4.

Naturally, the rotatable assembly 4 has to maintain its axial and radial position within the centrifugal separator 2 for the centrifugal separator 2 to operate reliably. Accordingly, the radial movement of the rotatable assembly 4 and the second end portion 36 of the elongated element 32 have to be limited. Thus, for instance, the seal 50 between the first and second portions 8, 8′ of the casing 8, 8′ and the elongated element 32 besides permitting radial movement also may have a limiting function to the radial movement. For instance, a radial movement of the second portion 8′ of the casing and a radial movement of the second end portion 36 of the elongated element 32 may be limited to a maximum of 1-5 mm, depending e.g., on the size of the centrifugal separator 2.

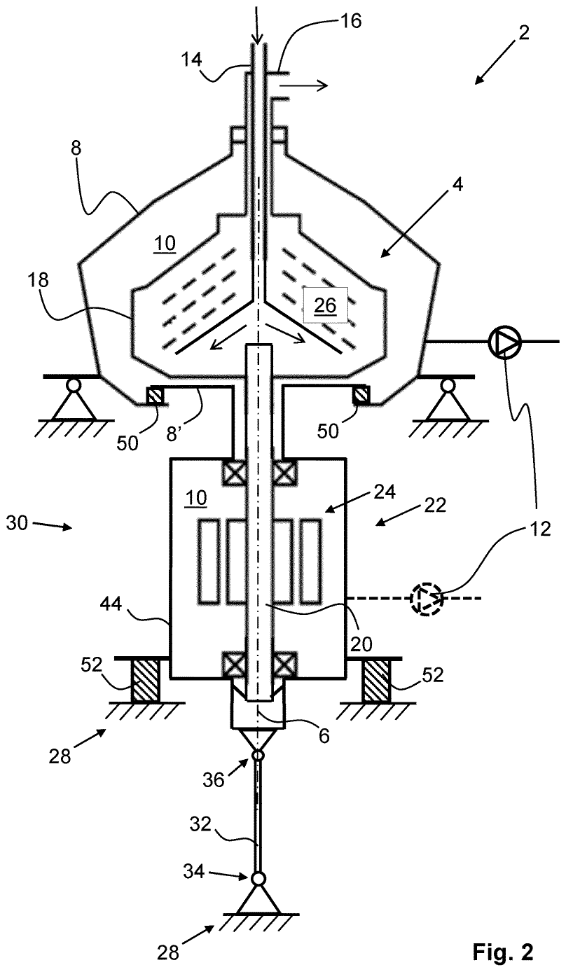

FIG. 2 schematically illustrates a cross section through a centrifugal separator 2 according to embodiments.

The centrifugal separator 2 of the FIG. 2 embodiments resembles in much the centrifugal separator 2 of the FIG. 1 embodiments. Accordingly, reference is also made to the above discussion of the FIG. 1 embodiments. In the following mainly, the differences between the embodiments will be discussed.

Again, the centrifugal separator 2 comprises a rotatable assembly 4 configured to rotate about a rotational axis 6, a casing 8, 8′ which delimits at least part of a space 10, a pump arrangement 12 connected to the space 10. The rotatable assembly 4 comprises a centrifuge bowl 18 and a spindle 20 with the centrifuge bowl 18 is arranged within the space 10 and within the casing 8, 8′. The rotatable assembly 4 is driven to rotate about the rotational axis 6 by a drive arrangement 22. The drive arrangement 22 may comprise an electric motor 24 and optionally a transmission.

Again, the space 10 is sealed. The pump arrangement 12 is configured to remove gas from the space 10 to provide a negative pressure within the space 10 during operation of the centrifugal separator 2.

Again, the rotatable assembly 4 is connected to a fixed structure 28 via a securing structure 30 that is rigid in at least one direction along the rotational axis 6 such that the centrifuge bowl 18 is maintainable in an axial position along the rotational axis 6 when the space 10 is subjected to the negative pressure during use of the centrifugal separator 2. The securing structure 30 comprises an elongated element 32 aligned with the rotational axis 6 when the rotatable assembly 4 is standing still. The securing structure 30 is connected to the fixed structure 28 at a first end portion 34 of the elongated element 32 and an opposite second end portion 36 of the elongated element 32 is movable in the radial direction. The elongated element 32 is nonelastic under tensile load.

An electric motor and/or a transmission (not shown) comprises a housing 44. The rotatable assembly 4 is journalled in the housing 44.

The housing 44 is connected to the casing 8, 8′ in such a manner that the space 10 extends into the housing 44. The connection between the casing 8, 8′ and the housing 44 is sealed.

Accordingly, in these embodiments, part of the space 10 is delimited by the housing 44. In this manner, the space 10 extends within the casing 8, 8′ and the housing 44.

Thus, the pump arrangement 12 is configured to remove gas from the space 10 extending both in the casing 8, 8′ and the housing 44 to provide a negative pressure within the space 10 during operation of the centrifugal separator 2.

The pump arrangement 12 may comprise one pump connected to the space 10 at one of the casing 8, 8′ and the housing 44. Alternatively, the pump arrangement 12 may comprise two pumps, one each connected to the casing 8, 8′ and the housing 44, respectively, as also indicated with the broken line pump at the housing 44 in FIG. 2.

In these embodiments, the rotatable assembly 4 is suspended via the drive arrangement 22. Accordingly, the seal 50 between the first and second portions 8, 8′ of the casing 8, 8′ has no suspending function for the rotatable assembly 4 or only a limited suspending function.

Again, the Rotatable Assembly 4 Is Journaled in the Housing 44.

According to embodiments, such as in the illustrated embodiments, the housing 44 is resiliently supported by the fixed structure 28. In this manner, the rotatable assembly 4 may be suspended via the drive arrangement 22.

For instance, resilient elements 52, such as rubber elements, may be provided between the housing 44 and the fixed structure 28 for providing the resilient support.

The resilient support will provide for a limited radial movement of the rotatable assembly 4 to handle e.g., rotor dynamic effects and imbalances of the rotatable assembly 44.

A different arrangement of the inlet conduit 14 and an outlet conduit 16 for a separated light phase are shown in FIG. 2 than in the FIG. 1 embodiments. Both these conduits 14, 16 are arranged above the centrifuge bowl 18 to fluidly connect with the separation chamber 26 in the centrifuge bowl 18. A separated sludge phase may be ejected via peripheral outlet openings (not shown) in the centrifuge bowl 18.

In the FIG. 2 embodiments, alternatively, an arrangement of inlet and outlet conduits 14, 16, 16′ as shown in FIG. 1 may be used.

Similarly, the arrangement of inlet and outlet conduit 14, 16 as shown in FIG. 2 may be used in the FIG. 1 embodiments.

In these embodiment, the second end portion 36 of the elongated element 32 is connected directly to the housing 44.

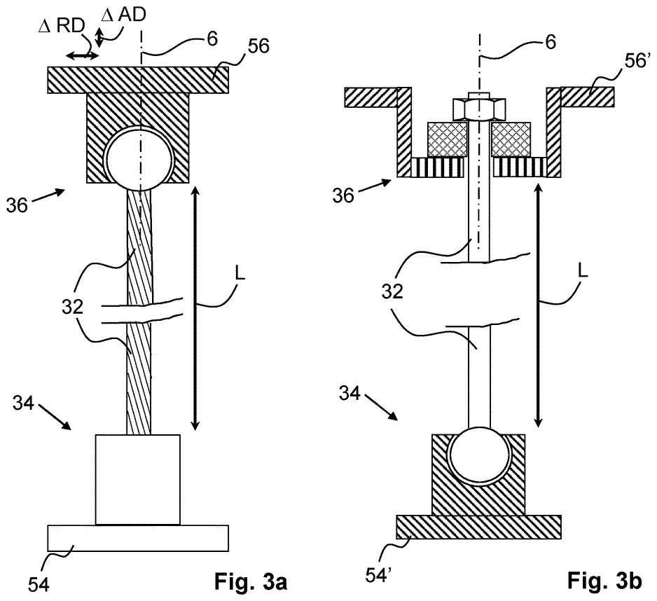

FIGS. 3a and 3b illustrate portions of securing structures 30 according to embodiments. Each of the securing structures 30 may be a securing structure 30 of a centrifugal separator 2 as discussed above with reference to FIGS. 1 and 2. Accordingly, in the following reference is also made to FIGS. 1 and 2.

More specifically, FIGS. 3a and 3b each show an elongated element 32 of a securing structure 30.

The elongated element 32 may have a length L within a range of 0.2-0.5 m. For instance, the length L may have a length L≥0.2 m.

In this manner, movement in the radial direction DRD (see FIG. 3a) of the second end portion 36 of the elongated element 32 will lead to a change of the second end portion 36 along the axial direction DAD that is minor and thus, does not affect the operation of the centrifugal separator 2.

Mentioned as an example; if the elongated element 32 has a length L of 0.3 m and the second end portion 36 thereof, starting from a vertical direction of the elongated element 32, is displaced in the radial direction a distance DRD of 1 mm, the resulting axial displacement DAD of the second end portion 36 is 0.003 mm.

Naturally, the longer the elongated element 32, the smaller the axial displacement DAD of its second end portion 36.

The elongated element 32 may comprise a wire such as a steel wire and/or a cord such as an aramid cord as shown in FIG. 3a and/or the elongated element 32 may comprise a tie rod as shown in FIG. 3b. Thus, nonelastic properties of the elongated element 32 may be provided.

Each first end portion 34 of the elongated elements 32 is provided with an attachment member 54, 54′ configured for attachment to a fixed structure 28. Each second end portion 36 of the elongated elements 32 is provided with an attachment member 56, 56′ for attachment to a portion of the securing structure, such as to a housing 44 or to a connection portion 48 of a conduit.

The different first and second attachment members 54, 54′, 56, 56′ are shown illustrate to different examples of attachment members. Other combinations of the different first and second attachment members 54, 54′, 56, 56′ than the illustrated may be used.

Since, the securing structure 30 is movable in the radial direction at the second end portion 36 of the elongated element 32, the elongated element 32 has to provide for such movement in the radial direction. Therefore, the first and second attachment members 54, 54′, 56, 56′ and/or the elongated element 32 may provide for pivotal movement.

In the FIG. 3a embodiments, the wire or cord of the elongated member 32 is embedded in the first attachment member 54. The wire or cord, as such provides the pivotal movement at the first attachment member 54.

The second attachment member 56 of the FIG. 3a embodiments and the first attachment member 54′ of the FIG. 3b embodiments comprise a ball joint that provides pivotal movement.

The second attachment member 56′ of the FIG. 3b embodiments comprises a resilient member 58 that provides pivotal movement. The elongated element 32 extends at least partially through the resilient member 58 and is attached at the resilient member 58. Thus, the elongated element 32 can change angle in relation to a centreline of the resilient member 58. The resilient member 58 may be made e.g., from a hard polyurethan material, which ensures limited compression of the resilient member 58 in the axial direction to ensure the maintenance of the axial position of the centrifuge bowl 18.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A centrifugal separator comprising:
a rotatable assembly configured to rotate about a rotational axis,
a casing which delimits at least part of a space,
a pump arrangement connected to the space,
an inlet conduit, and
at least one outlet conduit,
wherein the space is sealed, and the pump arrangement is configured to remove gas from the space to provide a negative pressure within the space during operation of the centrifugal-separator separator,
wherein the rotatable assembly comprises a centrifuge bowl and a spindle, the centrifuge bowl being arranged within the space and within the casing and the spindle being connected to the centrifuge bowl and extending between the centrifuge bowl and a drive arrangement outside the casing,
wherein the centrifuge bowl delimits a separation chamber and the inlet conduit and the at least one outlet conduit are arranged in fluid communication with the separation chamber from outside the casing,
wherein the rotatable assembly is suspended to permit movement thereof relative to at least portion of the casing in a radial direction with respect to the rotational axis,
wherein the rotatable assembly is connected to a fixed structure via a securing structure that is rigid in at least one direction along the rotational axis such that the centrifuge bowl is maintainable in an axial position along the rotational axis when the space is subjected to the negative pressure,
wherein the securing structure comprises an elongated element aligned with the rotational axis when the rotatable assembly is standing still,
wherein the securing structure is connected to the fixed structure at a first end portion of the elongated element and an opposite second end portion the elongated element is movable in the radial direction, and
wherein the elongated element is nonelastic under tensile load.

2. The centrifugal separator according to claim 1, wherein the securing structure comprises a housing, and
wherein the rotatable assembly is journalled in the housing.

3. The centrifugal separator according to claim 2, wherein the elongated element is connected at the second end portion to the housing.

4. The centrifugal separator according to claim 2, wherein part of the space is delimited by the housing.

5. The centrifugal separator according to claim 2, wherein the drive arrangement comprises an electric motor,
wherein the rotatable assembly comprises rotor of the electric motor, and
wherein the housing is a housing of the electric motor.

6. The centrifugal separator according to claim 2, wherein the spindle is journaled in the housing.

7. The centrifugal separator according to claim 2, wherein a first portion of the casing is connected to the fixed structure and a second portion of the casing is connected to the housing, and wherein a seal is provided between the first and second portions of the casing.

8. The centrifugal separator according to claim 7, wherein the spindle extends through the second portion of the casing.

9. The centrifugal separator according to claim 7, wherein the rotatable assembly is suspended at the seal between the first and second portions of the casing.

10. The centrifugal separator according to claim 2, wherein the housing is resiliently supported by the fixed structure.

11. The centrifugal separator according to claim 7, wherein a tensile load is transmittable via the second portion of the casing, the housing, and the elongated element to the fixed structure.

12. The centrifugal separator according to claim 1, wherein the elongated element has a length within a range of 0.2-0.5 m.

13. The centrifugal-separator separator according to claim 1, wherein the elongated-element element comprises a tie rod, and/or a wire, and/or a cord.

14. The centrifugal separator according to claim 1, wherein at least one of a first fluid connection between the inlet conduit and the separation chamber and a second fluid connection between the at least one outlet conduit and the separation chamber extends into the separation chamber at an end of the centrifuge bowl opposite to the spindle, and
wherein there is arranged a seal between the rotatable assembly and conduits at the end of the centrifuge bowl opposite to the spindle.

15. The centrifugal separator according to claim 15, wherein at least one of the first fluid connection between the inlet conduit and the separation chamber and the second fluid connection between the at least one outlet conduit and the separation chamber extends through the spindle.

16. The centrifugal separator according to claim 3, wherein part of the space is delimited by the housing.

17. The centrifugal separator according to claim 3, wherein the drive arrangement comprises an electric motor, wherein the rotatable assembly comprises a rotor of the electric motor, and wherein the housing is a housing of the electric motor.

18. The centrifugal separator according to claim 4, wherein the drive arrangement comprises an electric motor, wherein the rotatable assembly comprises a rotor of the electric motor, and wherein the housing is a housing of the electric motor.

19. The centrifugal separator according to claim 3, wherein the spindle is journaled in the housing.

20. The centrifugal separator according to claim 4, wherein the spindle is journaled in the housing.
